(19) United States
(12) Patent Application Publication
(10) Pub. No.: US 2022/0251874 A1
(43) Pub. Date: Aug. 11, 2022

(54) BOLT IDENTITY

(71) Applicant: ASSA ABLOY AB, Stockholm (SE)

(72) Inventors: Mats CEDERBLAD, Sigtuna (SE); Tomas JONSSON, Rönninge (SE); Per MACKEGÅRD, Solna (SE); Stefan JOHANSSON, Stockholm (SE)

(21) Appl. No.: 17/619,456

(22) PCT Filed: Jun. 16, 2020
(86) PCT No.: PCT/EP2020/066633

§ 371 Date: Dec. 15, 2021

(30) Foreign Application Priority Data
Jun. 19, 2019 (EP) 19181330.2

(51) Int. Cl. E05B 41/00; E05B 15/10

(52) U.S. Cl. CPC E05B 41/00; E05B 45/083; E05B 15/10

(57) ABSTRACT

It is provided a lock assembly (1) comprising: a striking plate assembly (10) comprising an aperture (12a, 12b); a first communication module (20a); and a bolt (13,14) being displaceable to enable movement through the at least one aperture (12a, 12b) of the striking plate assembly (10), the bolt (13,14) comprising a second communication module (20b); wherein the first communication module (20a) is configured to receive an identity of the bolt (13, 14) by communicating with the second communication module (20b) and wherein wireless signals from one of the first and second communication modules (20a, 20b) powers the other.

### TECHNICAL FIELD

The present disclosure relates to the field of locks and in particular to a lock assembly where a bolt provides its identity to a striking plate assembly.

### BACKGROUND

Locks and keys are evolving from the traditional pure mechanical locks. These days, electronic locks are becoming increasingly common. For electronic locks, electronic keys are used for authentication of a user. The electronic keys and electronic locks can communicate either over a wireless interface or a conductive interface. Such electronic locks and keys provide a number of benefits, including improved flexibility in management of access rights, audit trails, key management, etc.

In electronic locks, information of a status of a barrier (such as a door or a window) is often beneficial, whereby a sensor can be provided in the lock to detect the status of a locking bolt. For instance, a user can in this way ensure that a particular lock is in a locked state, e.g. to ensure that any such locks are secured when leaving the premises. There can e.g. be one sensor that detects if a barrier is open or closed. A further sensor can detect that a locking bolt protrudes through a striking plate.

An attacker could potentially tamper with such a system by inserting a loose locking bolt or other item in the corresponding aperture of the striking plate. In this way, the system (and thus the user) may consider the door or window to be locked, even though this is not the case. This can erroneously be interpreted as a physical space having been locked and secured, while, in fact, the actual door or window is unlocked and/or open.

### SUMMARY

One objective is to reduce the risk of an attacker tampering with a lock assembly into considering a lock to be secured when it is not.

According to a first aspect, it is provided a lock assembly comprising: a striking plate assembly comprising an aperture; a first communication module; and a bolt being displaceable to enable movement through the at least one aperture of the striking plate assembly, the bolt comprising a second communication module; wherein the first communication module is configured to receive an identity of the bolt by communicating with the second communication module and wherein wireless signals from one of the first and second communication modules powers the other.

The bolt may be a locking bolt.

The bolt may be a latch bolt.

The first communication module and the second communication module may be configured to communicate with each other wirelessly.

The first communication module may be powered by the second communication module.

The second communication module may be powered by the first communication module.

The lock assembly may be configured to only consider the bolt to be in a secured state when the identity of the bolt is determined to be valid.

The striking plate assembly may further comprise a sensor device for detecting proximate presence of the bolt.

According to a second aspect, it is provided a method, performed in a lock assembly comprising a striking plate assembly and a bolt being displaceable to enable movement through an aperture of the striking plate assembly. The method comprises the steps of: transmitting wireless signals from one of the first and second communication modules to power the other; transmitting, by a second communication module of the bolt, an identity of the bolt; and receiving, by a first communication module, the identity of the bolt.

The bolt may be a locking bolt.

The bolt may be a latch bolt.

The step of transmitting an identity may comprise transmitting the identity wirelessly.

The method may further comprise the step of: transmitting wireless signals from one of the first and second communication modules to power the other.

The method may further comprise the step of: considering the bolt to be in a secured state only when the identity of the bolt is determined to be valid.

The method may further comprise the step of: detecting, by a proximity sensor when the bolt has been retracted.

According to a third aspect, it is provided a computer program comprising computer program code which, when run on a lock assembly comprising a striking plate assembly and a bolt being displaceable to enable movement through an aperture of the striking plate assembly, causes the lock assembly to: transmit wireless signals from one of the first and second communication modules to power the other; transmit, by a second communication module of the bolt, an identity of the bolt; and receive, by a first communication module the identity of the bolt.

According to a fourth aspect, it is provided a computer program product comprising a computer program according to the third aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram showing an environment in which embodiments presented herein can be applied;

FIG. 2 is a schematic diagram illustrating one embodiment of the lock assembly of FIG. 1;

FIG. 3 is a flow chart illustrating embodiments of methods for verifying an identity of a bolt;

FIG. 4 is a schematic diagram illustrating components of the lock assembly of FIG. 1 and FIG. 2; and

FIG. 5 shows one example of a computer program product 90 comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

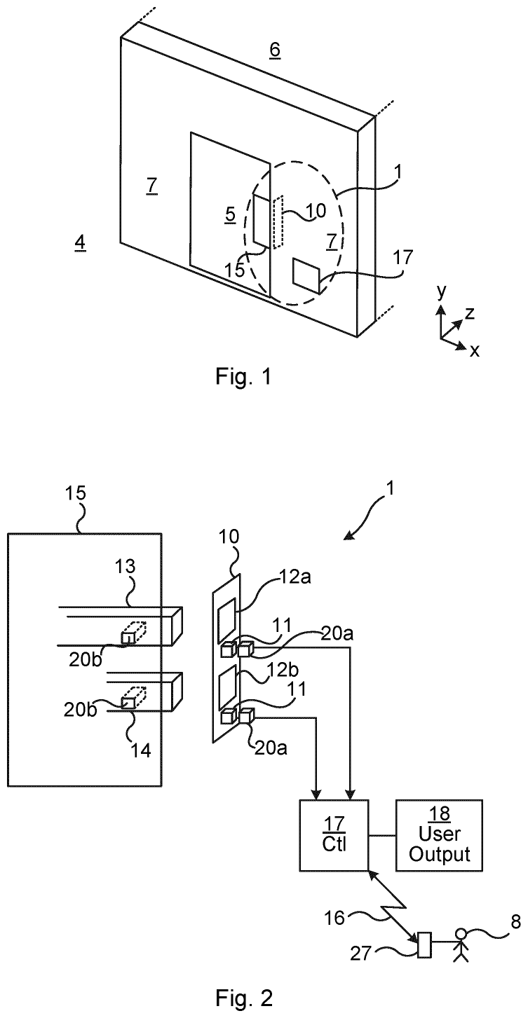

FIG. 1 is a schematic diagram showing an environment in which embodiments presented herein can be applied. Access to a physical space 6 is restricted by a physical barrier 5 which is selectively controlled to be in a locked state or an unlocked state. The physical barrier 5 can be a door, window, gate, hatch, cabinet door, drawer, etc. The physical barrier 5 is provided in a surrounding physical structure 7 (being a wall, fence, ceiling, floor, etc.) and is provided between the restricted physical space 6 and an accessible physical space 4. It is to be noted that the accessible physical space 4 can be a restricted physical space in itself, but in relation to this physical barrier 5, the accessible physical space 4 is accessible.

A lock assembly 1 is provided to secure the physical space 6. The lock assembly 1 comprises a striking plate assembly 10 and a lock section 15. One of the striking plate assembly 10 and the lock section 15 is provided in the barrier 5 and the other is provided in the surrounding structure 7 (as shown) or in an opposing door in a double door pair (not shown). For instance, the lock section 15 can be provided in the barrier 5 and the striking plate assembly 10 can be provided in the surrounding structure 7, as shown in FIG. 1, or vice versa.

The lock section 15 comprises one or more bolts (shown in FIG. 2). The bolt(s) are displaceable (linearly or otherwise) to enable movement through a corresponding one aperture of the striking plate assembly, whereby the bolt engages with the striking plate and the barrier is secured. The bolt can e.g. be in the form of a locking bolt and/or a latch bolt.

In one embodiment, the lock assembly 1 is an electronic lock. In order to unlock the barrier 5, a controller 17 is then provided. The controller 17 forms part of the lock assembly 1, which is controllable by the controller 17 to be set in an unlocked state or locked state. Alternatively, the lock is a mechanical lock, for which the locked/unlocked state is desired to be monitored.

FIG. 2 is a schematic diagram illustrating one embodiment of a lock assembly 1. The striking plate assembly 10 comprises a striking plate and optionally at least one sensor device 11. When present, the sensor device 11 is provided for detecting proximate presence of the bolt. In the embodiment shown in FIG. 2, there are two sensor devices ii, one for each bolt 13, 14. The striking plate can be made of metal and secures the position of the bolt(s) (locking bolt 13 and/or latch bolt 14) when extended through apertures 12a-b in the striking plate into the surrounding structure 7, thus making it difficult for an attacker to break open the barrier.

The lock assembly further comprises at least one instance of a first communication module 20a. In this example, there are two instances of first communication modules 20a, provided respectively by the apertures 12a-b. There are here two instances of first communication modules 20a, one for each bolt 13, 14.

Each bolt 13, 14 comprises a second communication module 20b. Each set of first communication module 20a and second communication module 20b communicate with each other. Optionally, this communication is encrypted. Alternatively or additionally, an authorisation protocol is employed, such as a challenge-response procedure. As explained in more detail below, this communication is used for the second communication module 20b to inform the first communication module 20a of the identity of the bolt. The identity can be in the form of an alphanumeric sequence, or pure numeric sequence, digitally communicated between the first communication module 20a and the second communication module 20b.

The striking plate assembly 10 is for use with a lock section 15 which comprises one or more bolts 13, 14 in the form of a locking bolt 13 and/or a latch bolt 14. The striking plate 10 comprises a first bolt aperture 12a through which the locking bolt 13 can pass. When the locking bolt 13 has passed through the first bolt aperture 12a, the lock section 15 is in a locked state.

The sensor device(s) 11 of the striking plate assembly 10 are used for detecting a status of the locking bolt(s) 13, 14. The status is either that the bolt has been extended through the aperture of the striking plate or that the locking bolt is not extended through the striking plate. When applied for the locking bolt 13, when this is extended through the striking plate, this indicates that the lock is in a locked state. Conversely, when the locking bolt 13 is not extended through the striking plate, the lock is in unlocked state. The sensor device 11 is provided attached to the striking plate 10, such that its proximity sensor is located adjacent to where the locking bolt 13 is intended to pass.

Each instance of the first communication module 20a is provided so that it can communicate with a corresponding second communication module 20b. The communication between the first and second communication modules 20a-b can be wireless. Wireless signals from one of the first and second communication modules 20a, 20b powers the other, e.g. by inductive power transfer. In this way, only one of the first and second communication modules needs to be provided with an integral power supply (e.g. battery) or external wire-based power link. The communication between the first and second communication modules 20a, 20b can be of any suitable type, e.g. RFID or a subset and/or modification of the RFID specification. Since this communication between the communication modules 20a, 20b is internal to the lock assembly 1, the communication protocol can be selected freely, and does not need to conform to any particular communication standard.

The proximity sensor of the sensor device 11 can be based on any one or more of electrical capacity, electrical inductivity, infrared light, magnetism (e.g. a hall sensor), photocell, sonar, mechanical switch etc. When the proximity sensor is an inductive sensor, this simplifies retrofitting, since a regular metal locking bolt presence can be detected with an inductive sensor. The sensor device 11 can be a self-contained device comprising the proximity sensor, battery, antenna(s), and control circuitry. Such a sensor device 11 is easy to integrate in the striking plate and can be replaced or upgraded when needed.

Optionally, a ferrite film is provided between the sensor and metal material close to the sensor. The ferrite film reduces the generation of Eddy currents in the metal material. The ferrite film can be provided on the sensor side or the metal side. In this way, energy loss due to the Eddy currents is greatly reduced.

A controller 17 can be connected to every instance of the first communication module 20a and sensor device 11. The interface between the controller 17 and the first communication module 20a and sensor device 11 can be implemented using a wireless interface or a wire-based interface. The wireless interface can e.g. be implemented using Bluetooth, Bluetooth Low Energy (BLE), any of the IEEE 802.15 standards, Radio Frequency Identification (RFID), any of the IEEE 802.11 standards, wireless USB (Universal Serial Bus), etc. The wire-based interface can e.g. be implemented using USB, Ethernet, serial connection (e.g. RS-485), etc.

Moreover, the controller 17 can comprise a user credential interface 16 for communicating with a user credential 27. The user credential interface 16 can be implemented using any suitable wireless interface, e.g. using Bluetooth, BLE, any of the IEEE 802.15 standards, RFID, Near Field Communication (NFC), any of the IEEE 802. 11 standards, wireless USB, etc. Alternatively or additionally, the user credential interface 16 can be implemented using wire-based communication, e.g. using USB, Ethernet, serial connection (e.g. RS-485), etc.

Optionally, the controller 17 is provided with a way to communicate with a remote control device (not shown), such as a smart phone, computer etc. for remote lock management. Using the remote communication, the controller 17 is remotely controllable, e.g. to allow access for a particular user credential or to remotely unlock the lock (e.g. for a tradesman, cleaner, child who have lost a key, etc.). Also, the remote communication enables event monitoring, e.g. of unlocking status, locking status, opening, closing, etc., which can be detected using the sensor device and communication modules. It is of particular importance that the lock status can be relied upon when the remote control interface is provided.

The user credential 27 can be implemented using any suitable device portable by a user and which can be used for authentication over the credential interface 16. The user credential 27 is typically carried or worn by the user 8 and may be implemented as a mobile phone, a smartphone, a key fob, wearable device, smart phone case, access card, electronic physical key, etc.

Using the user credential interface 16, the authenticity of the user credential 27 can be checked by the controller 17 in an access control procedure, e.g. using a challenge and response scheme. The authorisation to open the lock assembly 1 is then checked, either by the controller 17 itself, or by communicating with an external (local or remote) authorisation device (not shown) to reach an access decision whether to grant or deny access.

The controller 17 also receives sensor data from the sensor device 11 indicating the presence or absence of a bolt 13, 14. Presence of the locking bolt 13 indicates an extended locking bolt 13, corresponding to a locked state, and absence of the locking bolt 13 indicates a retracted locking bolt 13, corresponding to an unlocked state. Significantly, the identity of the bolt is also used by the controller 17. For instance, the controller 17 can be configured to only consider the bolt to be in a secured state when the identity of the bolt is determined to be valid. In this way, a loose bolt cannot be inserted in the striking plate to tamper with the lock assembly into considering the lock to be in a locked state. The identity is considered to be valid when its identity is on a list of (one or more) valid identities. In one embodiment, there is only one valid identity for a particular aperture (and thus a particular first communication module 20a). The valid identity/identities can be configured e.g. at deployment.

The controller 17 is configured to selectively control the lock assembly 1 based on the identity of the bolt and sensor data received from the sensor device 11, as well as user credential data received over the credential interface 16.

Using the access decision, the bolt identity as well as the sensor data, the controller 17 determines whether to retract or extend the locking bolt 13 by sending an appropriate control signal to the lock assembly 1.

Optionally, as shown in FIG. 2, the striking plate assembly 10 further comprises a second sensor device 11 for detecting a status of a separate latch bolt 14 of the lock assembly 1 to gain better information about the status of the door. When the latch bolt 14 is present, this indicates that the barrier 5 is closed. Conversely, when the latch bolt 14 is absent, this indicates that the barrier is open. Again, the identity of the bolt, i.e. latch bolt 14 here, is checked and the latch bolt is only considered to be provided through the corresponding aperture 12b when its identity is valid. Hence, the presence or absence of the latch bolt 14 in a second bolt aperture 12b of the striking plate 10, as detected by the second sensor device 11 and transmitted as sensor data to the controller 17, can be interpreted as whether the barrier 5 is open (when the latch bolt 14 is absent) or closed (when the latch bolt 14 is present).

A user output device 18 can also be provided, connected to the controller 17. The user output device 18 can be any one or more of a LED (light emitting diode), lamp, beeper, sound device, display, etc. The controller 17 is then configured to provide user feedback via the user output device 18. For instance, the user feedback can be used to indicate any of the following situations: access granted, access denied, access granted but no change (e.g. if the barrier is already open), etc. When the controller 17 is remotely controllable, the user output can optionally be provided in parallel to a device performing the remote control. For instance, if a user remotely unlocks the door for a tradesman, the successful unlocking can result in a green LED indicating that the door is unlocked to the tradesman, as well as an indicator on the user interface of the remote control device.

With the solution presented herein, it becomes extremely difficult for an attacker to tamper with a lock assembly into determining that a valid bolt is present by inserting a loose bolt or other metal piece into an aperture of the striking plate.

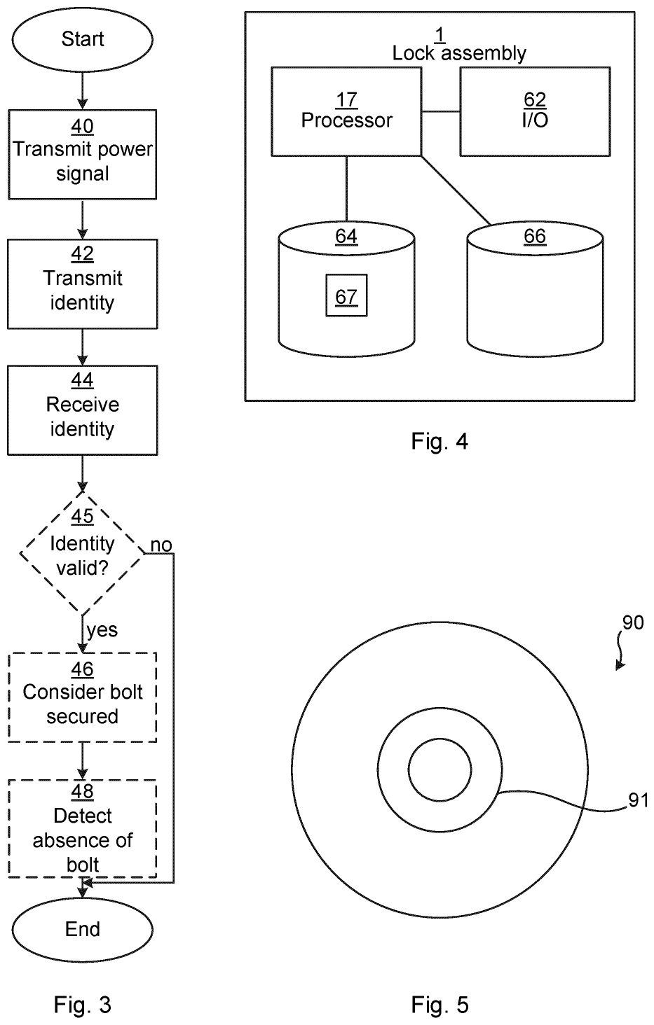

FIG. 3 is a flow chart illustrating embodiments of methods for determining an identity of a bolt. As explained above, the method is performed in a lock assembly comprising a striking plate assembly and a bolt being displaceable to enable movement through an aperture of the striking plate assembly. The method can be applied for either or both of the bolt being a locking bolt or a latch bolt.

In a transmit power signal step 40, the lock assembly transmits wireless signals from one of the first and second communication modules to power the other. This can e.g. be based on inductive power transfer.

It is to be noted that the rest of the method can only proceed if the power signal is transmitted. In other words, the identity of the bolt can only be obtained and verified in later steps if the power signal is transmitted.

In one embodiment, the first communication module is powered by the second communication module. In this case, a separate power source is provided to power the second communication module provided in the bolt. For instance, the bolt can contain a power source in the form of a battery or a wired or inductive connection to an external power supply. By requiring power to be provided in the bolt for the lock assembly to function, it is made even more difficult for an attacker to tamper with the lock assembly by inserting a loose bolt in the aperture of the striking plate to trick the system into considering the lock assembly to be in a locked state.

In one embodiment, the second communication module is powered by the first communication module. In this case, an external power supply is provided to power the first communication module.

In a transmit identity step 42, the lock assembly transmits, by a second communication module of the bolt, an identity of the bolt. The identity can be transmitted wirelessly.

In a receive identity step 44, the lock assembly receives, by a first communication module, the identity of the bolt.

In an optional conditional identity valid step 45 the lock assembly determines when the identity of the bolt is determined to be valid. When this is the case, the method proceeds to an optional consider bolt secured step 46. Otherwise, the method ends.

In the optional consider bolt secured step 46, the lock assembly considers the bolt to be in a secured state. This also indicates that the barrier is secured.

In the optional detect absence of bolt step 48, the lock assembly detects when the bolt has been retracted. This can be detected by a proximity sensor in the lock device. The proximity sensor can be made more energy efficient than the communication module, whereby polling of presence with the proximity sensor uses less energy or can occur more often than with the communication module. When the bolt is retracted when not expected to occur, this can indicate that a break-in is in progress.

FIG. 4 is a schematic diagram illustrating components of the lock assembly of FIG. 1 and FIG. 2. A processor 17 is provided using any combination of one or more of a suitable central processing unit (CPU), multiprocessor, microcontroller, digital signal processor (DSP), etc., capable of executing software instructions 67 stored in a memory 64, which can thus be a computer program product. The processor 17 could alternatively be implemented using an application specific integrated circuit (ASIC), field programmable gate array (FPGA), etc. The processor 17 can be configured to execute the method described with reference to FIG. 3 above.

The memory 64 can be any combination of random-access memory (RAM) and/or read-only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 17. The data memory 66 can be any combination of RAM and/or ROM.

The lock assembly 1 further comprises an I/O interface 62 for communicating with external and/or internal entities. For instance, the I/O interface 62 comprises components for communicating internally to the sensor device 11 and between the first communication module 20a and the second communication module 10b. The I/O interface 62 also comprises the optional user output device 18 and the user credential interface 16.

Other components of the lock assembly 1 are omitted in order not to obscure the concepts presented herein.

FIG. 5 shows one example of a computer program product 90 comprising computer readable means. On this computer readable means, a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 64 of FIG. 4. While the computer program 91 is here schematically shown as a track on the depicted optical disk, the computer program can be stored in any way which is suitable for the computer program product, such as a removable solid-state memory, e.g. a Universal Serial Bus (USB) drive.

Here now follows a list of embodiments from another perspective, enumerated with roman numerals.

i. A lock assembly comprising:

a striking plate assembly comprising an aperture;

a first communication module; and

a bolt being displaceable to enable movement through the at least one aperture of the striking plate assembly, the bolt comprising a second communication module;

wherein the first communication module is configured to receive an identity of the bolt by communicating with the second communication module.

ii. The lock assembly according to claim i, wherein the bolt is a locking bolt.

iii. The lock assembly according to claim i, wherein the bolt is a latch bolt.

iv. The lock assembly according to any one of the preceding claims, wherein the first communication module and the second communication module are configured to communicate with each other wirelessly.

v. The lock assembly according to claim iv, wherein wireless signals from one of the first and second communication modules powers the other.

vi. The lock assembly according to any one of the preceding claims, wherein the lock assembly is configured to only consider the bolt to be in a secured state when the identity of the bolt is determined to be valid.

vii. The lock assembly according to any one of the preceding claims, wherein the striking plate assembly further comprises a sensor device for detecting proximate presence of the bolt.

viii. A method, performed in a lock assembly comprising a striking plate assembly and a bolt being displaceable to enable movement through an aperture of the striking plate assembly, the method comprising the steps of:

transmitting, by a second communication module of the bolt, an identity of the bolt; and

receiving, by a first communication module, the identity of the bolt.

ix. The method according to claim viii, wherein the bolt is a locking bolt.

x. The method according to claim viii, wherein the bolt is a latch bolt.

xi. The method according to any one of claims viii to x, further comprising the step of:

transmitting wireless signals from one of the first and second communication modules to power the other.

xii. The method according to any one of claims viii to xi, further comprising the step of:

considering the bolt to be in a secured state only when the identity of the bolt is determined to be valid.

xiii. The method according to any one of claims viii to xii, further comprising the step of:

detecting, by a proximity sensor when the bolt has been retracted.

xiv. A computer program comprising computer program code which, when run on a lock assembly comprising a striking plate assembly and a bolt being displaceable to enable movement through an aperture of the striking plate assembly, causes the lock assembly to:

transmit, by a second communication module of the bolt, an identity of the bolt; and

receive, by a first communication module the identity of the bolt.

xv. A computer program product comprising a computer program according to claim xiv and a computer readable means on which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A lock assembly comprising:
a striking plate assembly comprising an aperture;
a first communication module; and
a bolt being displaceable to enable movement through the at least one aperture of the striking plate assembly, the bolt comprising a second communication module;
wherein the first communication module is configured to receive an identity of the bolt by communicating with the second communication module and wherein wireless signals from one of the first and second communication modules powers the other, wherein the first communication module is powered by the second communication module.

2. The lock assembly according to claim 1, wherein the bolt is a locking bolt.

3. The lock assembly according to claim 1, wherein the bolt is a latch bolt.

4. The lock assembly according to claim 1, wherein the first communication module and the second communication module are configured to communicate with each other wirelessly.

5. The lock assembly according to claim 1, wherein the lock assembly is configured to only consider the bolt to be in a secured state when the identity of the bolt is determined to be valid.

6. The lock assembly according to claim 1, wherein the striking plate assembly further comprises a sensor device for detecting proximate presence of the bolt.

7. A method, performed in a lock assembly comprising a striking plate assembly and a bolt being displaceable to enable movement through an aperture of the striking plate assembly, wherein the lock assembly comprises a first communication module and the bolt comprises a second communication module the method comprising:
transmitting wireless signals from one of the first and second communication modules to power the other, wherein the first communication module is powered by the second communication module;
transmitting, by a second communication module of the bolt, an identity of the bolt; and
receiving, by the first communication module, the identity of the bolt.

8. The method according to claim 7, wherein the bolt is a locking bolt.

9. The method according to claim 7, wherein the bolt is a latch bolt.

10. The method according to claim 7, further comprising:
considering the bolt to be in a secured state only when the identity of the bolt is determined to be valid.

11. The method according to claim 7, further comprising:
detecting, by a proximity sensor when the bolt has been retracted.

12. A computer program comprising computer program code which, when run on a processor of a lock assembly comprising a striking plate assembly and a bolt being displaceable to enable movement through an aperture of the striking plate assembly wherein the lock assembly comprises a first communication module and the bolt comprises a second communication module causes the lock assembly to:
transmit wireless signals from one of the first and second communication modules to power the other, wherein the first communication module is powered by the second communication module;
transmit, by a second communication module of the bolt, an identity of the bolt; and
receive, by a first communication module the identity of the bolt.

13. A computer program product comprising a computer program according to claim 12 and a computer readable means on which the computer program is stored.

14-15. (canceled)
